(19) United States
(12) Patent Application Publication
(10) Pub. No.: US 2004/0078474 A1
(43) Pub. Date: Apr. 22, 2004

(54) Systems and methods for scheduling user access requests

(76) Inventor: Ramkumar Ramaswamy, Plano, TX (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/274,434

(22) Filed: Oct. 17, 2002

(51) Int. Cl. G06F 15/16

(52) U.S. Cl. 709/229; 709/250

(57) ABSTRACT

An access request system has at least one content data store. A server is provided that has a scheduler, a port and a plurality of buffers. Each buffer corresponds to a service level for a request received from the data store. The connection scheduler applies an interpretative script to requests and the connection scheduler checks the port for requests.

### APPENDICES

Appendix A, which forms a part of this disclosure, provides exemplary pseudocode that illustrates one embodiment of the invention as disclosed herein.

### BACKGROUND OF THE INVENTION

1. Field of the Invention

This invention relates generally to methods and systems for scheduling user access requests, and more particularly, to methods and systems for scheduling user access requests in response to a probabilistic scheduling policy.

2. Description of the Related Art

Several protocols exist in which one computer (a “host”) receives and processes requests from a number of other computers (“clients”). For example, in applications involving the world-wide web, a server can receive and process many concurrent requests from different users on the internet, in this example, the server would be the host while each user device would be a client.

Requests can usually be grouped into sessions, with each session each having one or more related requests. For example, a multiple-request session could consist of a request requesting information over the world-Attorney wide web, and an associated response. Alternatively, a multiple-request session could consist of a commercial transaction, with related requests respectively used to locate a web site for a precise product, submit an order or billing and shipping information, and convey a confirmation of sale to a particular client. Whether a host is to process just a single request or a series of related requests, is usually important to quickly, accurately and completely service each request and each session.

The term “quality of service” refers to a host's ability to provide quick and consistent responses to a request, complete a session and consistency in doing so. As a particular host becomes more popular, and due to that popularity receives more requests, the host's processing resources can become stretched. For example, due to heavy traffic, a host may not be able to respond to a request at all, or the host may not provide a timely response (which can cause a client to “time-out” and generate an error). Poor quality of service can have significant consequences, as users may become frustrated and simply give up trying to reach a particular host, or the sponsor of the host may lose sales or fail to communicate needed information to any or all clients.

Two techniques are generally used to alleviate quality of service problems. First, more processing capacity can be added to the host, typically by either replacing the host with another, more powerful computer, or by providing multiple computers in parallel and delegating new requests to different ones of the multiple computers. While this first technique presents an effective way of reducing some quality of service problems, it is not always practical. For example, sometimes, due to inadequate planning, budgetary constraints or space constraints, additional processing capacity cannot be added. If demand for a host is not properly forecast, there may be a long lead time before additional processing capacity can be purchased and implemented. Additionally, the processing power may be in the placed inefficiently in the information system. A second technique calls for applying “admission control,” where only a certain number of client requests are processed (“admitted”) and the remainder are refused; of the requests which are in fact admitted, all are ideally handled in an expedient manner without degradation of quality of service as to those admitted requests. An advantage of this technique is that admission control can be implemented in software, thus facilitating quick, inexpensive use with little advance notice.

Unfortunately, typical admission control mechanisms operate by admitting requests on a request-by-request basis, and so, these typical admission control requests do not provide an adequate solution for multiple-request sessions. Also, the requests which are not admitted to the host are generally not handled at all, such that a client is not informed that the request has been refused or the client, if informed, is simply asked to “try again later.” Typically, a refused client must try repeatedly to obtain service with no guarantee that future requests will be processed. For these reasons and others, techniques generally used to alleviate quality of service problems are not always successful.

U.S. Pat. No. 6,006,269, incorporated herein by reference, discloses an admission control system having an admission control gateway, a deferral manager and a scheduler. When the admission control gateway receives a request that calls for a new client session, the gateway determines whether a processing threshold has been reached; if the threshold has been reached or surpassed, the request is passed to the deferral manager to formulate a response to the particular client. The scheduler is checked to determine a time when the host can expect to have processing resources available, and the deferral manager then formulates a time indication which tells the client when the client can expect to gain admission to the host.

An ISP system typically includes web and/or content servers that host contents for various customers or applications. The customers are the owners of the contents hosted in the ISP system such that subscribers or users can access the contents via their computer terminals. The content servers typically utilize Internet applications, such as electronic mail, bulletin boards, news groups, and World Wide Web access. The hosted contents are arranged in the form of content sites within the content servers. Each site may include a number of pages such as world wide web pages. A content site is typically for one customer while a particular customer may own a number of content sites.

However, the ISP system is not equipped to give different processing treatments to the users accessing a web site within the ISP system. All of the users of the ISP system receive the same treatment and no preferential treatment is provided for any class of users. Consequently, the ISP system does not support class-based service which allows access requests for the same content site to receive different processing treatments.

U.S. Pat. No. 6,304,906 discloses a data service system that prioritizes access requests into classes to provide preferential treatments.

A need exists for methods and systems for scheduling user access requests that have an improved ability to alleviate quality of service problems. There is a further need for methods and systems for scheduling user access requests which respond to all requests, whether or not those requests are actually admitted. Yet there is a further need for methods and systems for scheduling user access requests that provide relative service levels or response times

### SUMMARY OF THE INVENTION

Accordingly, an object of the present invention is to provide methods and systems for scheduling user access requests that provide an improved ability to alleviate quality of service problems.

Another object of the present invention is to provide methods and systems for scheduling all user requests.

Yet another object of the present invention is to provide methods and systems for scheduling user access requests that provides some level of service to all clients including those that have been refused admission.

Another object of the present invention is to provide methods and systems for scheduling user access requests that enable e-businesses to deliver predictable and consistent service levels.

A further object of the present invention is to provide methods and systems for scheduling user access requests with prespecified relative service levels Yet another object of the present invention is to provide methods and systems for scheduling user access requests with prespecified relative service levels in an environment that has constancy.

Yet another object of the present invention is to provide methods and systems for scheduling user access requests with prespecified relative service levels in an environment where there are a few classes of users and a large number in each class.

Another object of the present invention is to provide methods and systems for scheduling user access requests with prespecified relative service levels in a relatively short time duration.

Yet another object of the present invention is to provide methods and systems for scheduling user access requests that enable e-businesses to create different customer classes and service levels and serve them in terms of priority when there are changes in traffic and infrastructure.

A further object of the present invention is to provide methods and systems for scheduling user access requests that minimizes server and site meltdown under high level traffic conditions.

Yet a further object of the present invention is to provide methods and systems that proactively and precisely plan and provision infrastructures for future growth and for under certain conditions.

These and other objects of the present invention are achieved in a access request system that has at least one content data store. A server is provided that has a scheduler, a port and a plurality of buffers. Each buffer corresponds to a service level for a request received from the data store. The connection scheduler applies an interpretative script to requests and the connection scheduler checks the port for requests.

In another embodiment of the present invention, an access request system at least one content data store. A server is provided that has a scheduler, a port and a plurality of buffers. Each buffer corresponds to a requesting client type or a request type for requests received from requesting clients. The connection scheduler applies an interpreted script to requests and checks the port for requests.

In another embodiment of the present invention method of scheduling user access request provides a server that includes a scheduler, a port and a plurality of buffers. Each buffer corresponds to a service level for a request received from a data store. The number of users N is determined for each type of access requests to the server or sends requests to the server.

### BRIEF DESCRIPTION OF THE DRAWINGS

FIG. 1 illustrates one embodiment of an access system that implements one embodiment of the present invention.

FIG. 2 is a flow chart that illustrates one embodiment of the operation of the connection scheduler from the FIG. 1 access system.

FIG. 3 is a flow chart that illustrates one embodiment for handing requests from the connection scheduler.

### DETAILED DESCRIPTION OF THE PREFERRED EMBODIMENTS

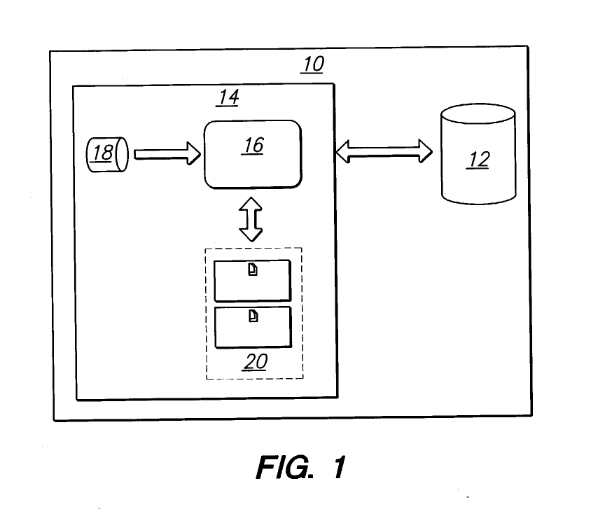

As illustrated in FIG. 1, one embodiment of the present invention is an access request system, generally denoted as 10 that includes at least one content data store 12 and a server 14. Server 14 has a scheduler 16, a port 18 and a plurality of buffers 20 that each correspond to a requesting client type or a request type for the requests that are received from requesting clients. In one embodiment, connection scheduler 16 applies an interpreted script to requests. Connection scheduler 16 checks port 18 for requests.

In another embodiment, connection scheduler 16 applies a probabilistic policy to requests. Preferably, the probabilistic scheduling policy can be changed by a server administrator. The server administrator changes the scheduling policy by editing a code file without recompilation.

A variety of servers 12 can be utilized including but not limited to, a web content servers, e-mail servers, a news servers, an e-commerce servers, a domain name servers, an address assignment servers, a proxy servers, a subscription management servers, an advertisement servers, or a session manager servers, and the like. Preferably, server 12 is a web content server.

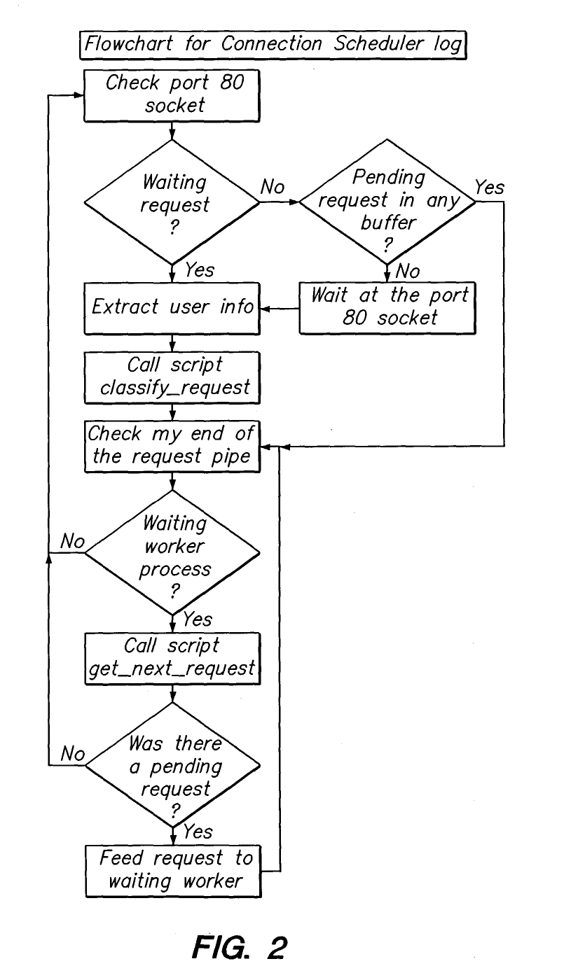

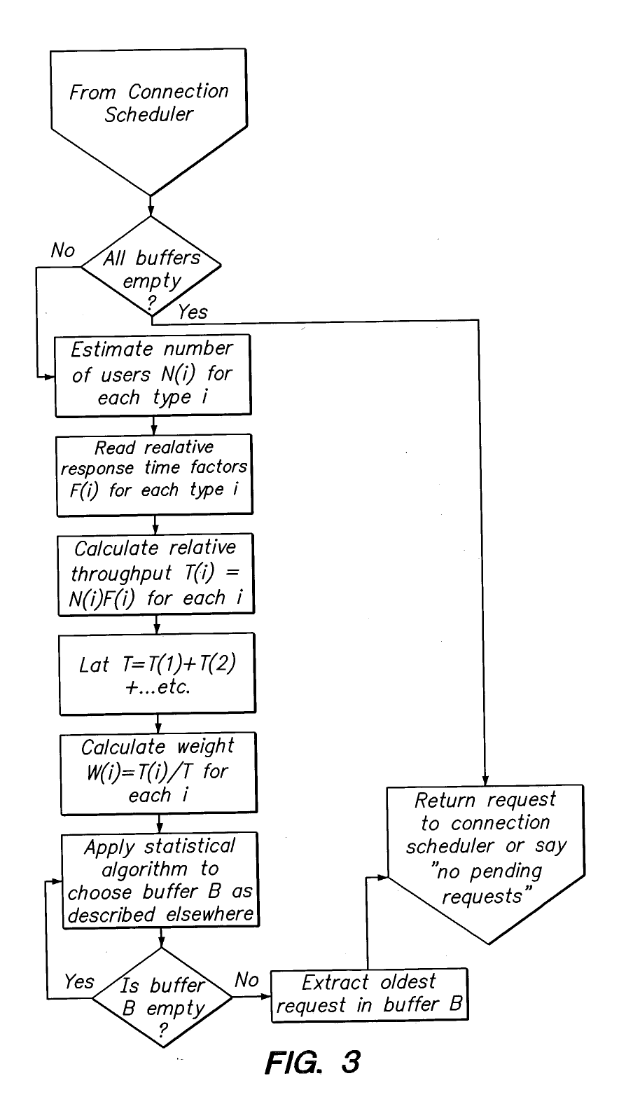

Reference is made to Appendix A, and the flow charts of FIGS. 2 and 3. Buffers 20 store the requests in order for them to be accepted by connection manager 16 for processing in response to a scheduling policy.

Connection scheduler 16 receives requests as they are received by server 12 and places them in buffers 20. Buffers 20 can be defined based on request type or requesting client types. Connection scheduler 16 polls buffers 20, applies a scheduling rule and decides from which buffer 20 to take the next request. Prior to running server 12, connection scheduler 16 specifies a relative response time for a type of requesting client or a type of request.

Connection scheduler 16 is configured to minimize starvation of requests. In one embodiment, connection scheduler 16 applies a randomized request selection algorithm to determine the next buffer 20 to take. In one embodiment, server 12 applies a process per connection model to requests in buffers 20.

Server 12 includes a plurality of worker processes that are each at an end of a request pipe 22 of server 12. The processing of request preferably occurs only when a worker process is available. Each worker process checks request pipe 22 for requests and connection scheduler 16 checks port 14 for requests. Each worker process takes turns looking at request pipe 22 for requests. Connection scheduler 16 checks request pipe 22 to see if there is a waiting worker process at the end of request pipe 22. Connection scheduler 16 keeps the request pending until there is a free worker process at the end of request pipe 22.

Processing is applied to requests in a buffer 20 when a worker process is available for the request. Only one worker process has access to request pipe 22 at any one time. A worker process is assigned a request, processes the request and then sends a response to the requesting client. Server 12 examines information in a request to determine a requesting client type or a request type. Server 12 determines a buffer number that corresponds to a requesting client type or request type and a classification rule. In response to the determination of the buffer number, server 12 stores the request in a corresponding buffer 20.

Connection scheduler 16 can provide a service level for each access request in response to, (i) a sender address of the access request, (ii) a tag contained in each of the access requests, a cookie, or a browser plug-in value, or a URL locator, and the like.

By way of illustration, and without limitation, in one embodiment server 12 determines the number of users N(i), where N(i) is the number of users of type (i) or the number of users firing requests of type (i). Server 12 reads a response time factor F(i), where F(i) is the response time factor for the number of users of type (i) or the number of users firing requests of type (i), for each request from a configuration file. The configuration file is in a memory of server 12. In response to the response time for each request, server 12 calculates a throughput factor T(i), where T(i) is the throughput factor for the number of users of type (i) or the number of users firing requests of type (i). The relative throughput factor T(i) is N(i)/F(i).

Server 12 calculates a weight factor W(i) for each user type to normalize the throughput factor. For a user type i the weight factor W(i) is equal to T(i)/(sum of all T's), where W(i) is the weight factor for the number of users of type (i) or the number of users firing requests of type (i).

Server 12 determines a buffer number for each request. A probability of a buffer 20 being selected for a request is in proportion to a value of its weight. The probability of a buffer i, where i is an integer, is proportional to a value of its weight W(i).

A buffer number is determined by:

generating a random number R with a value between 0 and 1;

locating a buffer i that meets the following conditions:

W(0)+W(1)+W(2)+ . . . +W(i-1) is <R; and

W(0)+W(1)+W(2)+ . . . +W(i) is >=R.

If a buffer 20 is empty, then another buffer 20 is selected in a randomized manner.

While the invention has been described in connection with what is presently considered to be the most practical and preferred embodiment, it is to be understood that the invention is not limited to the disclosed embodiment, but on the contrary it is intended to cover various modifications and equivalent arrangement included within the spirit and scope of the claims which follow.

What is claimed is:

1. A access request system, comprising:
at least one content data store; and
a server including a scheduler, a port and a plurality of buffers each corresponding to a service level for a request received from the data store, the connection scheduler applying an interpretative script to requests, the connection scheduler checks the port for requests.

2. The system of claim 1, wherein the buffers store the access requests so to be accepted by the connection manager for processing in response to a scheduling policy.

3. The system of claim 2, wherein a connection scheduler receives requests as they are received by the server and places them in the buffers

4. The system of claim 3, wherein the buffers are defined based on request or user types.

5. The system of claim 3, wherein the connection scheduler polls the buffers, applies a scheduling rule and decides from which buffer to take a next request.

6. The system of claim 3, wherein prior to running the server the connection scheduler specifies a relative response time for a type of user or a type of request.

7. The system of claim 6, wherein the connection scheduler minimizes starvation of a request.

8. The system of claim 3, wherein the connection scheduler applies a randomized request selection algorithm to determine the next buffer to take.

9. The system of claim 1, wherein the server applies a process per connection model to requests in the buffers

10. The system of claim 1, wherein the server includes a plurality of worker processes each at an end of a request pipe.

11. The system of claim 10, wherein processing of a request is applied only when a worker process is available.

12. The system of claim 10, wherein each worker process checks the request pipe for requests and the connection scheduler checks the socket for requests.

13. The system of claim 10, wherein each worker process takes turns looking at the request pipe for requests.

14. The system of claim 10, wherein the connection scheduler checks the request pipe to see if there is a waiting worker process at an end of the request pipe.

15. The system of claim 14, wherein the connection scheduler keeps the request pending until there is worker process at the end of the request pipe.

16. The system of claim 10, wherein processing is applied to requests in a buffer when a worker process is available for the request.

17. The system of claim 10, wherein only one worker process waits at the request line at a time.

18. The system of claim 10, wherein a worker process takes a request, processes the request and then sends a response to the client.

19. The system of claim 1, wherein the server examines user information for a request to determine a user type.

20. The system of claim 19, wherein the server determines a buffer number that corresponds to a user type and a classification rule.

21. The system of claim 20, wherein in response to the determination of the buffer number the server stores the request in a corresponding buffer.

22. The system of claim 2, wherein the connection scheduler provides a service level for each access request in response to a sender address of the access request.

23. The system of claim 1, wherein the connection scheduler provides service levels of access requests in response to a tag contained in each of the access requests, a cookie, or a browser plug-in value.

24. The system of claim 1, wherein the connection scheduler provides service levels access requests in response to a pathname or a URL locator.

25. The system of claim 1, wherein the server applies a probabilistic scheduling policy for access requests.

26. The system of claim 25, wherein the probabilistic scheduling policy can be changed by a server administrator.

27. The system of claim 25, wherein the server administrator changes the scheduling policy by editing a code file without recompilation.

28. The system of claim 1, wherein the servers is selected from a web content servers, e-mail servers, a news servers, an e-commerce servers, a domain name servers, an address assignment servers, a proxy servers, a subscription management servers, an advertisement servers, or a session manager servers.

29. The system of claim 1, wherein the server is a web content server.

30. The system of claim 1, wherein the server determines the number of users N(i), where N(i) is the number of users of type (i) or the number of users firing requests of type (i).

31. The system of claim 30, wherein the server reads a response time factor F(i) for each request from a configuration file, where F(i) is the time factor for the number of users of type (i) or the number of users firing requests of type (i).

32. The system of claim 31, wherein the configuration file is in a memory of the server.

33. The system of claim 30, wherein in response to the response time for each request, the server calculates a throughput factor T(i), where T(i) is the throughput factor for the number of users of type (i) or the number of users firing requests of type (i).

34. The system of claim 33, wherein the relative throughput factor T(i) is N(i)/F(i).

35. The system of claim 34, wherein the server calculates a weight factor W(i) for each user type to normalize the throughput factor, where W(i) is the weight factor for the number of users of type (i) or the number of users firing request of type (i).

36. The system of claim 35, wherein for a user type i the weight factor W(i) is equal to T(i)/(sum of all T's).

37. The system of claim 36, wherein the server determines a buffer number for each request.

38. The system of claim 37, wherein a probability of a buffer being selected for a request is in proportion to a value of its weight.

39. The system of claim 38, wherein the probability of a buffer i, where i is an integer, is proportional to a value of its weight W(i).

40. The system of claim 39, wherein a buffer number is determined by:
generating a random number R with a value between 0 and 1;
locating a buffer i that meets the following conditions:
W(0)+W(1)+W(2)+ . . . +W(i-1) is <R; and
W(0)+W(1)+W(2)+ . . . +W(i) is >=R.

41. The system of claim 40, wherein if a buffer is empty, then another buffer is selected in a randomized manner according to claim 40.

42. An access request system, comprising:
at least one content data store; and
a server including a scheduler, a port and a plurality of buffers each corresponding to a requesting client type or a request type for requests received from requesting clients, the connection scheduler applying an interpreted script to requests, the connection scheduler checks the port for requests.

43. The system of claim 42, wherein the buffers store the access requests so to be accepted by the connection manager for processing in response to a scheduling policy.

44. The system of claim 42, wherein a connection scheduler receives requests as they are received by the server and places them in the buffers

45. The system of claim 44, wherein the buffers are defined based on request or requesting client types.

46. The system of claim 44, wherein the connection scheduler polls the buffers, applies a scheduling rule and decides from which buffer to take a next request.

47. The system of claim 44, wherein prior to running the server the connection scheduler specifies a relative response time for a type of requesting client or a type of request.

48. The system of claim 47, wherein the connection scheduler minimizes starvation of a request.

49. The system of claim 44, wherein the connection scheduler applies a randomized request selection algorithm to determine the next buffer to take.

50. The system of claim 44, wherein the connection scheduler applies a randomized request selection algorithm to determine the next buffer to take.

51. The system of claim 42, wherein the server applies a process per connection model to requests in the buffers

52. The system of claim 42, wherein the server includes a plurality of worker processes each at an end of a request pipe.

53. The system of claim 52, wherein processing of a request is applied only when a worker process is available.

54. The system of claim 52, wherein each worker process checks the request pipe for requests and the connection scheduler checks the socket for requests.

55. The system of claim 52, wherein each worker process takes turns looking at the request pipe for requests.

56. The system of claim 52, wherein the connection scheduler checks the request pipe to see if there is a waiting worker process at an end of the request pipe.

57. The system of claim 56, wherein the connection scheduler keeps the request pending until there is worker process at the end of the request pipe.

58. The system of claim 52, wherein processing is applied to requests in a buffer when a worker process is available for the request.

59. The system of claim 52, wherein only one worker process waits at the request line at a time.

60. The system of claim 52, wherein a worker process takes a request, processes the request and then sends a response to the client.

61. The system of claim 1, wherein the server examines user information for a request to determine a user type.

62. The system of claim 61, wherein the server determines a buffer number that corresponds to a user type and a classification rule.

63. The system of claim 61, wherein in response to the determination of the buffer number the server stores the request in a corresponding buffer.

64. The system of claim 44, wherein the connection scheduler provides a service level for each access request in response to a sender address of the access request.

65. The system of claim 42, wherein the connection scheduler provides service levels of access requests in response to a tag contained in each of the access requests, a cookie, or a browser plug-in value.

66. The system of claim 42, wherein the connection scheduler provides service levels access requests in response to a pathname or a URL locator.

67. The system of claim 42, wherein the server applies a probabilistic scheduling policy for access requests.

68. The system of claim 67, wherein the probabilistic scheduling policy can be changed by a server administrator.

69. The system of claim 67, wherein the server administrator changes the scheduling policy by editing a code file without recompilation.

70. The system of claim 42, wherein the servers is selected from a web content servers, e-mail servers, a news servers, an e-commerce servers, a domain name servers, an address assignment servers, a proxy servers, a subscription management servers, an advertisement servers, or a session manager servers.

71. The system of claim 42, wherein the server is a web content server.

72. The system of claim 42, wherein the server determines the number of users N(i), where N(i) is the number of users of type (i) or the number of users firing requests of type (i).

73. The system of claim 72, wherein the server reads a response time factor F(i) for each request from a configuration file, where F(i) is the response time factor for the number of users of type (i) or the number of users firing requests of type (i).

74. The system of claim 73, wherein the configuration file is in a memory of the server.

75. The system of claim 72, wherein in response to the response time for each request, the server calculates a throughput factor T(i), where T(i) is the throughput factor for the number of users of type (i) or the number of users firing requests of type (i).

76. The system of claim 75, wherein the relative throughput factor T(i) is N(i)/F(i).

77. The system of claim 76, wherein the server calculates a weight factor W(i) for each user type to normalize the throughput factor, where W(i) is the weight factor for the number of users of type (i) or the number of users firing requests of type (i).

78. The system of claim 77, wherein for a user type i the weight factor W(i) is equal to T(i)/(sum of all T's).

79. The system of claim 78, wherein the server determines a buffer number for each request.

80. The system of claim 79, wherein a probability of a buffer being selected for a request is in proportion to a value of its weight.

81. The system of claim 80, wherein the probability of a buffer i, where i is an integer, is proportional to a value of its weight W(i).

82. The system of claim 81, wherein a buffer number is determined by:
generating a random number R with a value between 0 and 1;
locating a buffer i that meets the following conditions:
W(0)+W(1)+W(2)+ . . . +W(i-1) is <R; and
W(0)+W(1)+W(2)+ . . . +W(i) is >=R.

83. The system of claim 82, wherein if a buffer is empty, then another buffer is selected in a randomized manner according to claim 81.

84. A method of scheduling user access request, comprising:
providing a server that includes a scheduler, a port and a plurality of buffers each corresponding to a service level for a request received from a data store; and
determining the number of users N for each type of access requests to the server or sending requests to the server.

85. The method of claim 84, further comprising:
reading a response time factor F(i) for each request from a configuration file, where F(i) is the response time factor for the number of users of type (i) or the number of users firing requests of type (i).

86. The method of claim 85, wherein the configuration file is in a memory of the server.

87. The method of claim 85, further comprising:
calculating a throughput factor T(i) in response to the response time for each request, where T(i) is the throughput factor for the number of users of type (i) or the number of users firing requests of type (i).

88. The method of claim 87, wherein the relative throughput factor T(i) is N(i)/F(i), where N(i) is the number of users of type (i) or the number of users firing requests of type (i).

89. The method of claim 88, further comprising:
calculating a weight factor W for each user type to normalize the throughput factor, where W(i) is the weight factor for the users of type (i) or the number of users firing requests of type (i).

90. The method of claim 89, wherein for a user type i the weight factor W(i) is equal to T(i)/(sum of all T's).

91. The method of claim 90, further comprising:
determining a buffer number for each request.

92. The method of claim 91, wherein the buffer number represents a probability of the buffer being selected for a request is in proportion to a value of its weight.

93. The method of claim 92, wherein the probability of a buffer i, where i is an integer, is proportional to a value of its weight W(i)

94. The method of claim 93, wherein a buffer number is determined by:
generating a random number R between 0 and 1;
locating a buffer i that meets the following conditions:
W(0)+W(1)+W(2)+ . . . +W(i-1) is <R; and
W(0)+W(1)+W(2)+ . . . +W(i) is >=R.

95. The method of claim 94, wherein if a buffer is empty, then another buffer is selected in a randomized manner according to claim 93.
